(19) United States
(12) Patent Application Publication
(10) Pub. No.: US 2023/0418329 A1
(43) Pub. Date: Dec. 28, 2023

(54) Dock and Keyboard System

(71) Applicant: LENOVO (SINGAPORE) PTE. LTD, SINGAPORE (SG)

(72) Inventors: Ali Ent, Morrisville, NC (US); Jeffrey E. Skinner, Morrisville, NC (US); Alden Rose, Morrisville, NC (US); Jung Hwan Hong, Morrisville, NC (US); Ghwang Hyun Lim, Morrisville, NC (US)

(21) Appl. No.: 17/849,613

(22) Filed: Jun. 25, 2022

(51) Int. Cl. G06F 1/16; G06F 3/023

(52) U.S. Cl. CPC G06F 1/1632; G06F 3/0231; G06F 1/1669

(57) ABSTRACT

A system can include a dock that includes a base housing that includes a planar docking surface; and a keyboard housing that magnetically couples to the planar docking surface, where the keyboard housing includes a keyboard that includes depressible keys.

### TECHNICAL FIELD

Subject matter disclosed herein generally relates to docks and keyboards for computing and display devices.

### BACKGROUND

A system can include a display assembly with a display and a keyboard that can receive input.

### SUMMARY

A system can include a dock that includes a base housing that includes a planar docking surface; and a keyboard housing that magnetically couples to the planar docking surface, where the keyboard housing includes a keyboard that includes depressible keys. Various other apparatuses, assemblies, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a perspective view of an example of a system with an example of a keyboard housing and an example of a dock;

FIG. 2 is an exploded perspective view of the keyboard housing and the dock of FIG. 1;

FIG. 3 is a side view of an example of a keyboard housing and a dock;

FIG. 4A and FIG. 4B are a series of side views of the keyboard housing and the dock of FIG. 3;

FIG. 5 is a perspective view of an example of a system;

FIG. 6 is a perspective view of an example of a system;

FIG. 7 is a series of perspective views of example scenarios;

FIG. 8 is a perspective view of an example of a system;

FIG. 9 is a series of side views of an example of a dock;

FIG. 10 is a side view of an example of a dock;

FIG. 11 is a block diagram of examples of features of a keyboard housing and/or a dock; and

FIG. 12 is a diagram of an example of a system.

### DETAILED DESCRIPTION

The following description includes the best mode presently contemplated for practicing the described implementations. This description is not to be taken in a limiting sense, but rather is made merely for the purpose of describing the general principles of the implementations. The scope of the invention should be ascertained with reference to the issued claims.

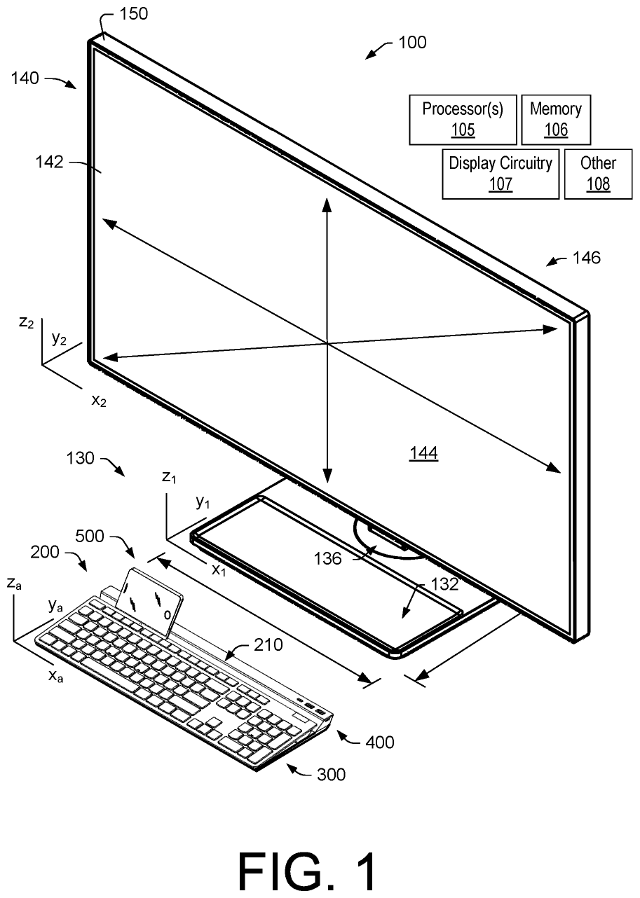

FIG. 1 shows a perspective view of an example of a system 100 that can include one or more processors 105, memory 106 accessible to at least one of the one or more processors 105, display circuitry 107 and one or more other components 108, which can include electronic circuitry, instructions stored in the memory 106 and executable by at least one of the one or more processors 105, etc. As an example, the system 100 can include one or more batteries such as, for example, one or more lithium-ion batteries that can be rechargeable. As an example, the system 100 may include one or more accessories, peripherals, etc.

In the example of FIG. 1, the system 100 includes an example of a system 200 that includes a keyboard housing 300 coupled to a dock 400 where either or both may include or be operatively coupled to at least one of the one or more processors 105 (e.g., via wire, via wireless communication circuitry, etc.). In the example of FIG. 1, the keyboard housing 300 is positioned with respect to the dock 400 to form a slot 210 that can be utilized to support one or more mobile devices 500 (e.g., mobile display devices).

As shown in FIG. 1, the system 100 includes a display assembly 140 with a display 142 that may utilize one or more technologies (e.g., LED, LCD, etc.). The display assembly 140 can include a display side 144, a back side 146 and a frame 150. The display circuitry 107 can be operatively coupled to at least one of the one or more processors 105, for example, to receive data, instructions, etc., for rendering text, graphics, images, etc., to the display side 144 of the display 142.

As an example, the display circuitry 107 can include one or more graphics processing units (GPUs) and, for example, one or more of the one or more processors 105 can be a central processing unit (CPU). As an example, the display circuitry 107 can include input circuitry such as touch circuitry, digitizer circuitry, etc., such that the display side 144 is an input surface. For example, the display side 144 may receive input via touch, a stylus, etc. As an example, the display assembly 140 can include a touchscreen display where a finger, a stylus, etc., can be utilized; noting sensing as to input may occur with or without physical contact between a finger and the display side 144, between a stylus and the display side 144, etc., depending on the type of input circuitry utilized (e.g., resistive, capacitive, acoustic wave, infrared, optical, dispersive signal, etc.).

In the example of FIG. 1, the system 100 can include a base 130 that includes an upper surface 132 and an arm 136 that is operatively coupled to the display assembly 140. For example, the arm 136 can extend from the base 130 where the display assembly 140 includes an arm mount that couples the arm 136 to the display assembly 140, for example, on the back side 146 of the display assembly 140 that is opposite the display side 144 of the display assembly 140. As an example, the base 130 and the arm 136 can be a stand for the display assembly 140.

As shown in the example of FIG. 1, the display side 144 may be centered along a centerline of the system 100 and may be disposed at an angle that can be defined by the base 130 or a flat support surface such as a desktop, a tabletop, a countertop, etc., where the base 130 or the flat support surface can be planar and horizontal. As shown, the arm 136 rises from the base 130 at an angle that may be normal to the base 130 or the flat support surface (e.g., a 90 degree angle). As to an angle of the display side 144, it may be 90 degrees, greater than 90 degrees or less than 90 degrees.

As shown, the base 130 and the display assembly 140 and/or the display side 144 can be defined with respect to one or more coordinate systems such as, for example, one or more Cartesian coordinate systems (see, e.g., x₁, y₁, z₁ and x₂, y₂, z₂). As shown, the display side 144 can be defined by a display area, which may be two-dimensional for a substantially flat (e.g., planar) display surface or which may be three-dimensional for a curved display surface, noting that such a curve may be of a relatively large radius of curvature (e.g., 50 cm or more) that gives the display a gentle curve (e.g., consider a radius of approximately the length of an extended arm of a user as traced by movement left and right from a shoulder of a user positioned in front of the display surface by an ergonomic distance). As shown, the arm 136 of the base 130 can be utilized to provide a gap or clearance between a lower edge of the display assembly 140 and a support surface on which the base 130 is supported (e.g., a desktop, tabletop, countertop, etc.). Such a gap may provide for rotation of the display 142 (e.g., from a landscape orientation to a portrait orientation).

As an example, the base 130 can include a platform, for example, defined in part by the upper surface 132, which may be a keyboard housing and/or a dock platform that can be utilized for placement of the keyboard housing 300 and/or the dock 400. For example, consider storing the keyboard housing 300 and/or the dock 400 on the base 130 where a gap between the upper surface 132 and the display assembly 140 can accommodate the keyboard housing 300 and/or the dock 400. In the example of FIG. 1, the upper surface 132 may be recessed, include a raised border, be disposed at a slight angle (e.g., less than approximately 30 degrees), include wireless charging circuitry that may provide for charging a battery of the keyboard housing 300 and/or the dock 400.

In the example of FIG. 1, the keyboard housing 300 and the dock 400 are illustrated along with a Cartesian coordinate system with xₐ, yₐ and zₐ coordinates that may be utilized to describe one or more features of the keyboard housing 300 and/or the dock 400. As shown, the coordinate xₐ can define a length (side to side), the coordinate yₐ can define a depth (front to back) and the coordinate zₐ can define a height (bottom to top). As shown, the upper surface 132 of the base 130 may be defined where the coordinate x₁ defines a length, the coordinate y₁ defines a depth and the coordinate z₁ defines a height. As an example, an area or footprint of the keyboard housing 300 and/or the dock 400 may be less than or equal to an area or footprint of the upper surface 132 of the base 130. Where the upper surface 132 includes a raised border or is recessed, the keyboard housing 300 and/or the dock 400, or a portion thereof, may be of an area that is less than an area of the upper surface 132.

As mentioned, the base 130 may include charging circuitry where, for example, when the keyboard housing 300 and/or the dock 400 is positioned on the base 130, one or more rechargeable batteries of the keyboard housing 300 and/or the dock 400 may be charged (e.g., via a contact and/or contactless interface, which may be a wireless interface). A wireless interface may include one or more features of the Qi standard.

Components that operate with the Qi standard utilize electromagnetic induction between coils. For example, a wireless charging system can include a base station that is connected to a power source for providing inductive power and a positionable device or assembly that can consume the provided inductive power. A base station can include a power transmitter that includes a transmitter coil that generates an oscillating magnetic field and the positionable device or assembly can include a power receiver that includes a receiver coil. In such an arrangement, a magnetic field can induce an alternating current in the receiver coil via Faraday's law of induction. To make transfer or power more efficient, a system can provide for close spacing of coils, shielding on their surfaces, etc.

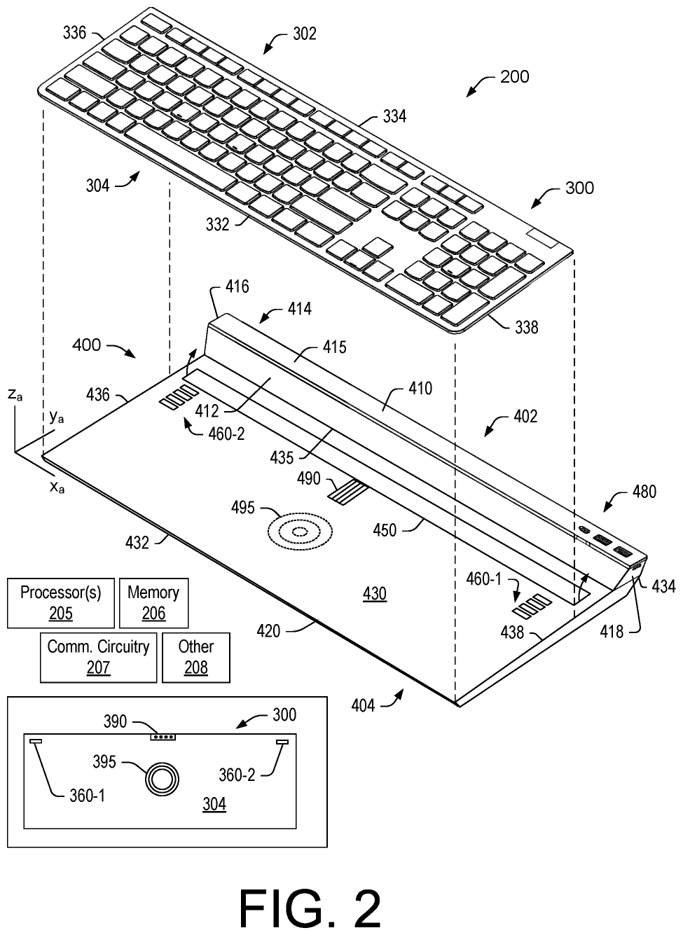

FIG. 2 shows an exploded perspective view of an example of the system 200 that includes the keyboard housing 300 and the dock 400 of FIG. 1. As shown, the system 200 can include the keyboard housing 300 and the dock 400, which may be in a physically coupled state with the keyboard housing 300 in contact with the dock 400 or in a physically de-coupled state with the keyboard housing 300 not in contact with the dock 400. In various examples, a wired and/or a wireless interface can provide for electronic coupling of the keyboard housing 300 and the dock 400.

As shown in the example of FIG. 2 the system 200 can include one or more processors 205, memory 206 accessible to at least one of the one or more processors 205, communication circuitry 207 and one or more other components 208, which can include electronic circuitry, instructions stored in the memory 206 and executable by at least one of the one or more processors 205, etc. As an example, the system 200 can include one or more batteries such as, for example, one or more lithium-ion batteries that can be rechargeable. As an example, the system 200 may include one or more accessories, peripherals, etc.

Various features of the system 200, the keyboard housing 300 and/or the dock 400 can be defined with respect to a Cartesian coordinate system with coordinates xₐ, yₐ and zₐ.

As shown in the example of FIG. 2, the keyboard housing 300 can include a top surface 302, a bottom surface 304, a front edge 332, a back edge 334 and opposing left and right edges 336 and 338. As shown, the keyboard housing 300 has a rectangular shape (e.g., a rectangular footprint).

As shown in the example of FIG. 2, the dock 400 can include a top surface 402, a bottom surface 404, a front edge 432, a back edge 434 and opposing left and right edges 436 and 438. The dock 400 can include a ridge 410 and a base housing 420 where the ridge 410 extends outwardly from the base housing 420 and where the ridge 410 may extend between the edges 436 and 438 where the ridge 410 includes a front facing surface 412, a back facing surface 414, opposing end facing surfaces 416 and 418 and a top facing surface 415. The base housing 420 of the dock 400 can also include a planar docking surface 430 that extends from the front edge 432 to an intermediate edge 435 where the planar docking surface 430 meets the front facing surface 412 of the ridge 410, where a corner may be formed by the planar docking surface 430 and the front facing surface 412 of the ridge 410.

As shown in the example of FIG. 2, the dock 400 can include various features such as, for example, a retractable bar 450 that may translate and/or rotate between a retracted position and an extended position, one or more pieces of ferromagnetic material 460-1 and 460-2 that may be arranged for securely positioning the keyboard housing 300 on the dock 400, an interface 490 that may interact with a corresponding interface 390 of the keyboard housing 300 and a wireless interface 495 that may interact with a corresponding wireless interface 395 of the keyboard housing 300. As an example, the interface 490 may be an electronic interface and/or an optical interface that can provide for data interactions. As an example, an electronic interface may be a contact interface such as a pogo-pin interface or other spring biased interface. As an example, an interface may be a connector interface that mates connectors. As an example, the wireless interface 495 may include features of the Qi standard, which can provide for power and/or data interactions. For example, the keyboard housing 300 can include an antenna and a battery where power can be transmitted from an antenna of the wireless interface 495 to the antenna of the keyboard housing 300 (see, e.g., the wireless interface 395) for purposes of charging the battery and/or operating other circuitry of the keyboard housing 300.

As to the one or more pieces of ferromagnetic material 460-1 and 460-2, these may include one or more sets where the keyboard housing 300 can be adjustable on the planar docking surface 430, for example, to adjust a dimension of the slot 210 (see, e.g., the slot 210 in FIG. 1). As shown, one or more sets may be arranged with respect to the y a dimension for translatable adjustment of the keyboard housing 300 to provide a desired slot dimension of the slot 210 as may be formed by the back edge 334 of the keyboard housing 300 and the front facing surface 412 of the ridge 410 of the dock 400. As an example, the interface 490 and/or the wireless interface 495 may be suitable and/or adjustable to accommodate a change in position of the keyboard housing 300 on the planar docking surface 430.

As shown in an inset view of the bottom surface 304 of the keyboard housing 300, the keyboard housing 300 can include one or more pieces of ferromagnetic material 360-1 and 360-2 that can cooperate with the one or more pieces of ferromagnetic material 460-1 and 460-2. For example, such ferromagnetic material can include one or more permanent magnets.

As to the interfaces 390 and 490, one or both of them may include a dimension or dimensions suitable for connection where a slot is formed or where no slot is formed between the keyboard housing 300 and the dock 400, and optionally to provide for one or more slot dimensions where a slot is formed. For example, consider one of the interfaces 390 and 490 as including pogo-pins while the other one of the interfaces 390 and 490 includes electrical contacts that may extend along the y a dimension. In such an approach, the pogo-pins can make contact with the electrical contacts over a range of positions of the keyboard housing 300 on the dock 400.

As an example, the dock 400 can include one or more ports 480, which may include a USB type of port (e.g., USB-C, etc.) and/or one or more other types of ports. As mentioned, the dock 400 may include a battery and/or may include or provide for connection of a cable such as a power and/or data cable. As an example, the keyboard housing 300 and/or the dock 400 can provide for wired connection and/or wireless connection to a computing device, which may be a mobile device such as, for example, the mobile device 500 as shown in FIG. 1. As an example, the system 200 can include one or more instances of BLUETOOTH circuitry. As an example, each of the keyboard housing 300 and the dock 400 may include BLUETOOTH circuitry for communications therebetween and/or with one or more other devices (e.g., computing devices, peripherals, etc.). As an example, the system 200 can utilize ultra-wideband (UWB) technology (e.g., consider technology of the IEEE 802.15.4 standard, etc.).

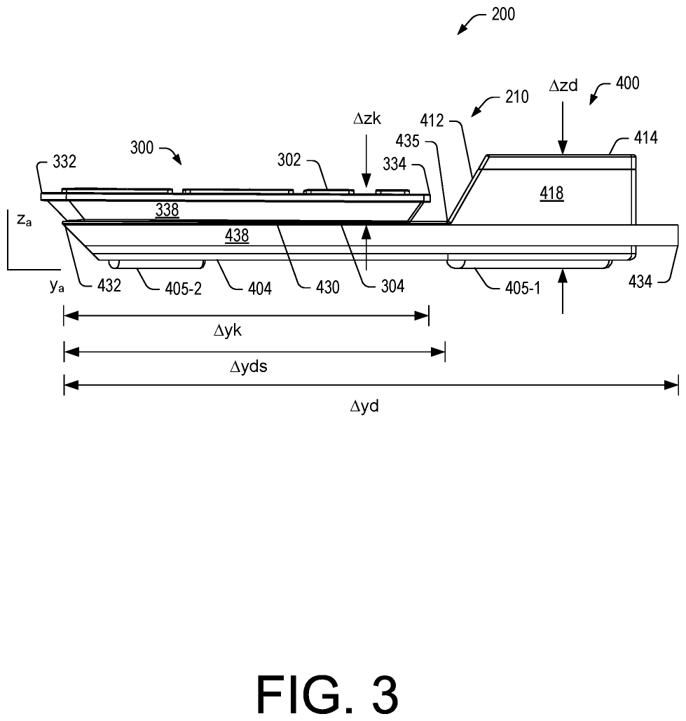

FIG. 3 shows a side view of an example of the system 200 where the keyboard housing 300 is positioned on the planar docking surface 430 of the dock 400. In the example of FIG. 3, the dock 400 is shown as including one or more feet 405-1 and 405-2, which may be polymeric, optionally elastomeric. As an example, the one or more feet 405-1 and 405-2 may be suitable for contacting the platform 130 as shown in FIG. 1. In FIG. 3, the slot 210 is shown as being defined at least in part by the back edge 334 of the keyboard housing 300 and the front facing surface 412 of the ridge 410, where a bottom of the slot 210 can be defined by the planar docking surface 430 where it extends to the intermediate edge 435 that can form a corner with the front facing surface 412. In the example of FIG. 3, the front facing surface 412 is disposed at an angle with respect to the planar docking surface 430 where the angle may be equal to or greater than 90 degrees. Such an angle may define a tilt of a mobile device disposed at least in part in the slot 210, for example, as shown in the example of FIG. 1.

FIG. 3 also shows various dimensions, including a keyboard depth Δyk, a keyboard height Δzk, a dock height Δzd and a dock depth Δyd. As shown in the example of FIG. 3, the keyboard depth Δyk is less than the dock depth Δyd and the keyboard height Δzk is less than the dock height Δzd; noting that the dock height Δzd can be greater than or equal to the keyboard height Δzk. As shown, the planar docking surface 430 can be of a depth Δyds that is greater than the keyboard depth Δyd such that the slot 210 is formed. As an example, the keyboard housing 300 may be positioned further back such that the back edge 334 contacts the front facing surface 412, which may cover the intermediate edge 435 such that the slot 210 is not formed. As an example, where a user desires formation of the slot 210, the keyboard housing 300 can be appropriately positioned and where a mobile device is inserted into the slot 210, there may be contact between the keyboard housing 300, the mobile device and the dock 400 (e.g., a stack-up of components along the yₐ dimension).

As an example, the dock 400 can include one or more magnets and/or one or more other features for securing the keyboard housing 300 to the dock 400 such that they may be carried together with a reduced risk of the keyboard housing 300 separating from the dock 400 (see, e.g., the material 460-1 and 460-2 of the example of FIG. 2). In such an example, the keyboard housing 300 may be positioned with or without the slot 210. For example, a series of magnets may provide for a number of secure positions that include a no slot position and at least one slot position, noting that a number of slot positions may be provided for an adjustable slot dimension (e.g., to accommodate a mobile device of a particular thickness, at a particular angle, etc.).

As an example, the dock 400 can include grooves that receive feet of the keyboard housing 300 where the keyboard housing 300 can be adjustable front to back to provide for a slot or no slot, optionally with slot dimensioning. In such an example, the keyboard housing 300 can include feet that can be interference-fit (e.g., press-fit) into the grooves such that a suitable amount of frictional force exists to hold the position of the keyboard housing 300 when typing and optionally when carrying the keyboard housing 300 and the dock 400 as an assembled unit. As an example, a set of grooves may be provided and arranged, for example, in a manner akin to the material 460-1 and 460-2 of the example of FIG. 2 or in another arrangement. In such an approach, the keyboard housing 300 can include feet suitable sized for receipt by a selected pair of grooves to thereby adjustably determine whether a slot exists or not and optionally a slot dimension. For example, consider the bottom surface 304 of the keyboard housing 300 to include feet (e.g., elastomeric, etc.) at positions of the one or more pieces of ferromagnetic material 360-1 and 360-2 that can cooperate with grooves at positions of the one or more pieces of ferromagnetic material 460-1 and 460-2. As explained, cooperating features can provide for alignment and/or securing a keyboard housing to a dock where, for example, interfaces can be aligned for transfer of power and/or data.

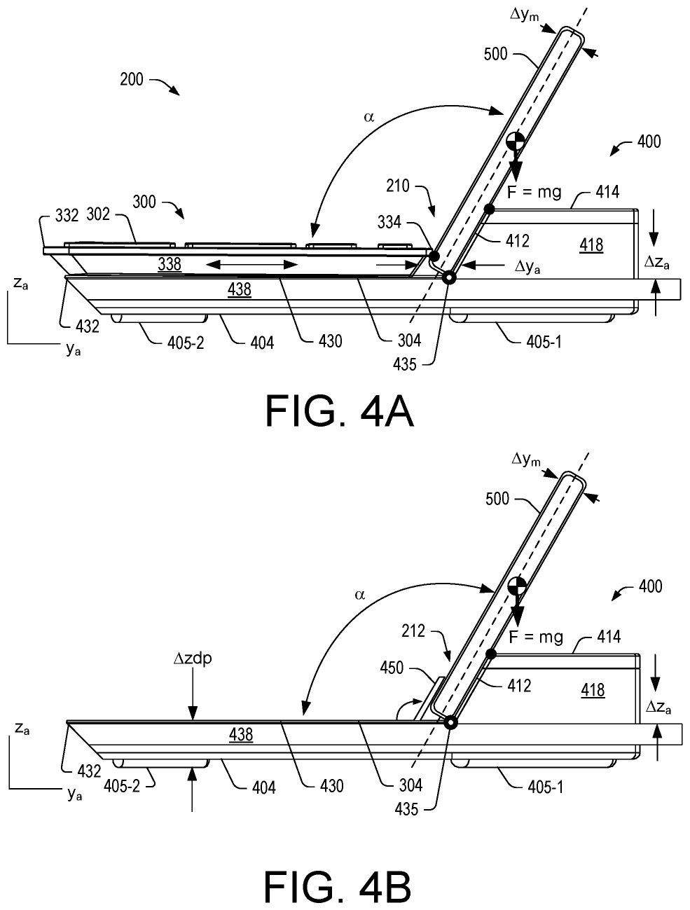

FIG. 4A shows a side view of an example of the system 200 along with an example of the mobile device 500 as supported in the slot 210 formed by the keyboard housing 300 and the dock 400. Various dimensions are shown in FIG. 4A, including slot dimensions Δyₐ and Δzₐ and mobile device thickness Δyₘ, which is less than or equal to the slot dimension Δyₐ. As explained, the keyboard housing 300 may be translatably positionable on the planar docking surface 430 for adjusting the slot 210, for example, to adjust the dimension Δyₐ of the slot 210 to accommodate a mobile device thickness and/or to adjust a tilt angle α of a mobile device supported in the slot 210.

FIG. 4B shows a side view of an example of the dock 400 without the keyboard housing 300 and with the mobile device 500. In the example of FIG. 4B, the retractable bar 450 is in its extended state (e.g., via translation and/or rotation) to form a slot 212 with respect to the front facing surface 412 of the dock 400. Hence, in such an example, the dock 400 may support a mobile device whether the keyboard housing 300 is in contact with the dock 400 or not in contact with the dock 400. As an example, the retractable bar 450, which may be referred to as a retractable stop, may be a rotatable flap or a pop up ridge. Where a rotatable flap is utilized, it may be spring biased and apply a biasing force to the mobile device 500, which may help to secure the mobile device in the slot 212.

In the examples of FIG. 4A and FIG. 4B, the height or depth of the slots 210 and 212 is relatively small compared to a dimension of the mobile device 500 such that a display of the mobile device 500 is not obscured or not substantially obscured (e.g., less than 15 percent obscured).

As shown in FIG. 4A and FIG. 4B, the mobile device 500 may be supported in the slot 210 or the slot 212 via its mass and gravity (see, e.g., F=mg). In such an example, a torque may be established such that force is applied by the mobile device 500 to the back edge 334 of the keyboard housing 300 or the retractable bar 450 and to the front facing surface 412 of the dock 400. The mobile device 500 may or may not contact the planar docking surface 430; noting that in the examples of FIG. 4A and FIG. 4B, the mobile device 500 is fully inserted such that it contacts the planar docking surface 430; noting that it may be pulled outwardly from the slot 210 or the slot 212 a bit such that it does not contact the planar docking surface 430 yet contacts the back edge 334 or the retractable bar 450 and the front facing surface 412 and is suitably, stably supported in the slot 210 or the slot 212.

In the examples of FIG. 4A and FIG. 4B, the dimension Δzₐ can be a vertical depth of the slot 210 or the slot 213 from an uppermost point to a point on the planar docking surface 430. As an example, the vertical depth may be less than 4 centimeters, less than 3.5 centimeters or less than 3 centimeters such that a majority portion of a display of a mobile device may be visible when the mobile device is in the slot 210 or the slot 212. As to the planar docking surface 430, it may extend from the intermediate edge 435 to the front edge 432 a dimension of approximately 8 centimeters or more (e.g., consider 10 centimeters or more) where the dimension may be less than approximately 20 centimeters.

As an example, the back edge 334 of the keyboard housing 300 can be an elastomeric edge (e.g., surface) that may provide for increased friction with respect to a mobile device such as a glass display surface of a mobile device. In such an example, the back edge 334 may increase grip to help stabilize the mobile device and provide for reduced risk of damage and/or marring of the mobile device. As an example, the front facing surface 412 may be an elastomeric surface and/or may include an elastomeric edge. As an example, an elastomeric material may be utilized that is elastically deformable. For example, consider one or more polymeric materials that may include a natural rubber, a synthetic rubber, a blend of rubbers, etc.

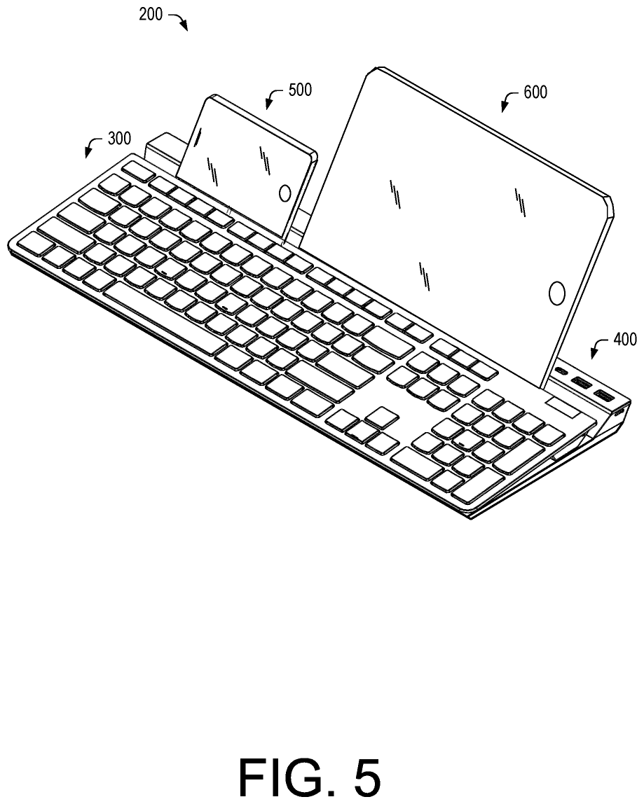

FIG. 5 shows an example of the system 200 with mobile devices 500 and 600 supported by the slot 210 and/or the slot 212 (e.g., depending on whether a retractable bar is utilized). In the example of FIG. 5, the keyboard housing 300 may be selectable operatively coupled to the mobile device 500 and/or to the mobile device 600. In such an example, the mobile device 500 may be a smart phone and the mobile device 600 may be a tablet computing device (e.g., a slate device), both of which include a respective display and communication circuitry.

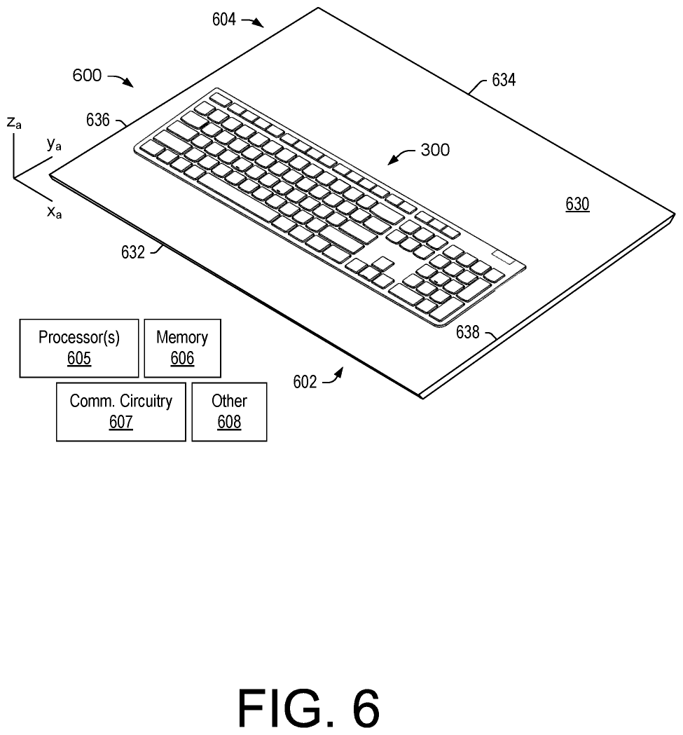

FIG. 6 shows an example of the keyboard housing 300 physically coupled to an example of the mobile device 600, which may be of an area or footprint that is larger than that of the keyboard housing 300. As shown, the mobile device 600 can include a front, display side 602, a back side 604, opposing edges 632 and 634 and opposing edges 636 and 638 and a planar docking surface 630 that is on the back side 604. As an example, the keyboard housing 300 can include one or more magnets and the mobile device 600 can include one or more magnets and/or other ferromagnetic material such that a magnetic attraction force can be established to physically couple the keyboard housing 300 to the mobile device 600. While the keyboard housing 300 is shown being physically coupled to the back side 604 of the mobile device 600, it may be physically coupled to the front, display side 602.

As an example, where the keyboard housing 300 is positioned over a portion of a display of the mobile device 600, the mobile device 600 may render information to another portion of the display where depressible keys of the keyboard housing 300 can be utilized to interact with the mobile device 600. For example, the mobile device 600 may detect the keyboard housing 300 as covering a portion of its display such that the mobile device 600 adjusts rendering of information to its display in a format that comports with a non-obscured portion of its display. In such an example, detection may be via a communication protocol and/or via one or more sensors (e.g., a proximity sensor, an ambient light sensor, a camera, a microphone, etc.), which may be part of the keyboard housing 300 and/or part of the mobile device 600.

As shown in the example of FIG. 6 the mobile device 600 can include one or more processors 605, memory 606 accessible to at least one of the one or more processors 605, communication circuitry 607 and one or more other components 608, which can include electronic circuitry, instructions stored in the memory 606 and executable by at least one of the one or more processors 605, etc. As an example, the mobile device 600 can include one or more batteries such as, for example, one or more lithium-ion batteries that can be rechargeable. As an example, the mobile device 600 may include one or more accessories, peripherals, etc.

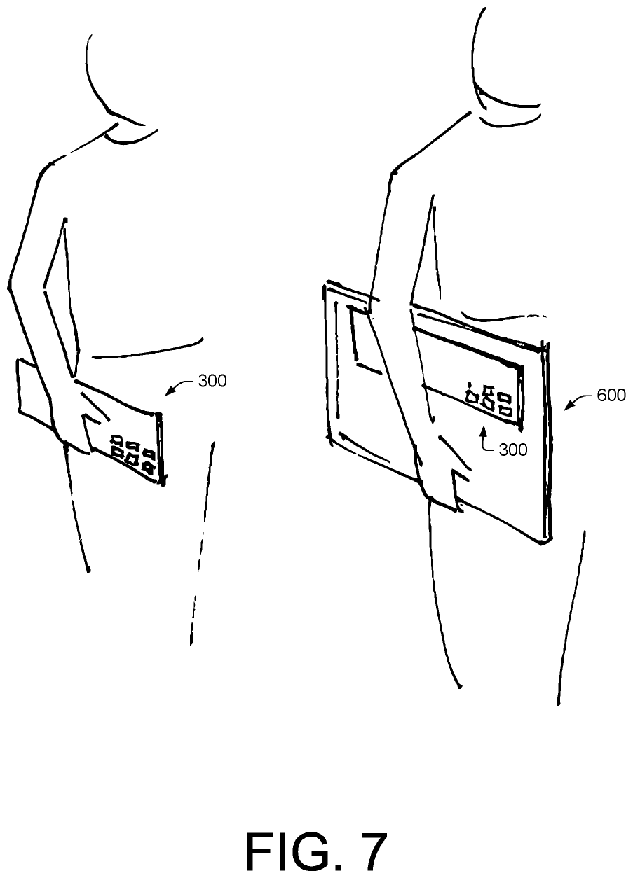

FIG. 7 shows example scenarios where a user may carry by hand the keyboard housing 300 alone or the keyboard housing 300 as physically coupled to the mobile device 600.

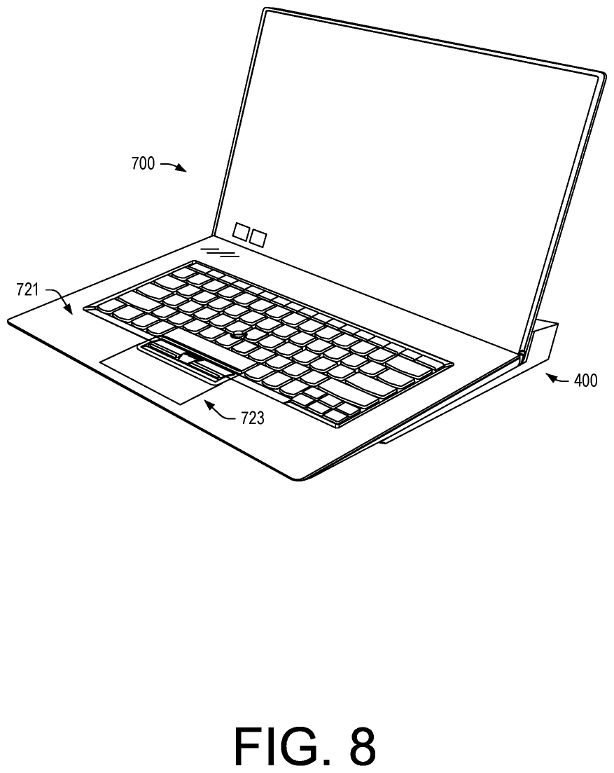

FIG. 8 shows an example of the dock 400 along with a notebook computing device 700. As shown in the example of FIG. 8, the dock 400 may be utilized to dock the notebook computing device 700 for one or more purposes such as, for example, to extend port capabilities, for supply of power, to position the notebook computing device 700 in a more ergonomic position, etc. As an example, the notebook computing device 700 can include one or more features of the keyboard housing 300. For example, consider one or more of the features shown in FIG. 2 with respect to the bottom side 304 of the keyboard housing 300 (e.g., one or more interfaces, one or more pieces of ferromagnetic material, one or more feet, etc.). In the example of FIG. 8, the notebook computing device 700 is shown as including a palm rest portion 721 and a touch pad 723. As an example, a keyboard housing and/or a dock can include a palm rest portion and/or a touch pad. For example, in FIG. 2, the keyboard housing 300 and/or the dock 400 may be extended forward to provide a surface for use as a palm rest and/or a surface that includes a touch pad.

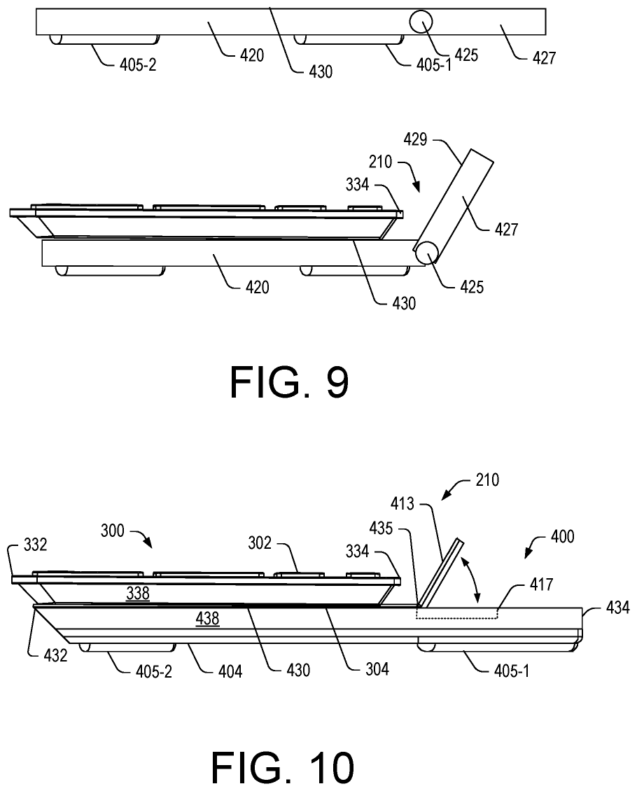

FIG. 9 shows a series of side views of an example of the dock 400 as including a hinge assembly 425 as part of the base housing 420. As shown, the hinge assembly 425 can provide for a relatively flat and planar configuration of the dock 400 where the hinge assembly 425 provides for rotating a flap 427 to a desired angle with respect to the planar docking surface 430. As shown, the flat 427 includes a surface 425 that can be a front facing surface. In FIG. 9, the keyboard housing 300 is shown as including the back edge 334, which can define the slot 210 with the surface 425. In the example of FIG. 9, the dock 400 may be more easily stored, transported, etc., in the relatively flat and planar configuration with the flap 427 depolyable as desired. In the example of FIG. 9, the dock 400 may also include the retractable bar 450, which may provide for forming the slot 212 with or without the keyboard housing 300 being present.

FIG. 10 shows a side view of an example of the keyboard housing 300 and an example of the dock 400 where the dock 400 includes a retractable flap 413 that can be extended from a recess 417 of the base housing 400. When the retractable flap 413 is retracted into the recess 417, the dock 400 may be substantially flat and planar, which may ease storage and/or transport thereof.

As an example, a keyboard housing may be relatively thin and lightweight, which can facilitate transport. In such an example, the keyboard housing may be suitable for coupling to a dock where the dock can provide added mass, which may make the keyboard housing more stable, as may be desired in various scenarios. In such an example, the keyboard housing may be relatively thin and lightweight and have a relatively low power consumption and a relatively small battery, which may be rechargeable or not rechargeable. For example, such a keyboard housing may be designed for temporary use by itself and longer term use when coupled to a dock, which may provide additional power to the keyboard housing where the additional power can be sufficient for longer term usage of the keyboard housing than the keyboard housing's on-board power store. For example, a dock can include a battery such as a rechargeable lithium-ion battery and the keyboard housing may include a small battery or small batteries such as coin form factor or AA or AAA types of batteries; noting that in some examples, a keyboard housing may include a relatively small lithium-ion battery that is rechargeable. As an example, a dock can include a cable that can receive power from a power source such as a USB port of a computing device, a USB power outlet plug, etc., such that the dock can provide a relatively continuous and uninterruptable supply of power.

As explained, a keyboard housing can include built in mounting magnets such that it can couple to a dock and/or couple to a computing device (e.g., a tablet computing device, etc.). In such examples, the keyboard housing can be transportable with a dock and/or a computing device as a unit.

As an example, a system that includes a dock and a keyboard housing can be an alternative to a desktop keyboard that plugs in where the only option for transportation is to unplug the desktop keyboard and carry the full keyboard device with its cable along with a computing device that will be receiving input from the desktop keyboard. As to a desktop wireless keyboard, again, the entire device must be transported, including its batteries where the desktop wireless keyboard is not configured to couple to a computing device and hence needs to be carried separately from the computing device or stacked in a manner where there is not attraction force or other mechanism to keep them from sliding or slipping with respect to one another.

As explained, a system can include separate parts, one being a keyboard housing and the other being a dock. As an example, a dock may be provided with a depth that is greater than a depth of a keyboard housing and may include a palm rest portion and optionally a touch pad. As an example, a keyboard housing may include a palm rest portion and optionally a touch pad.

In various examples, a slot can be formed between a keyboard housing and a dock where the slot can receive a portion of a mobile device to support the mobile device at a suitable viewing angle. While a mobile device is mentioned, such a slot may be formed and utilized for one or more other purposes, additional or alternatively. For example, consider support of a stylus, one or more spare batteries, a sticky-pad, a voice recorder, a calculator, a pack of chewing gum, glasses (e.g., computer or other glasses), a memory storage device, ear buds, etc.

As explained, a keyboard housing and a dock may physically and electrically connect via one or more mechanisms such as, for example, magnets and pogo-pins. As an example, when a user needs to transport a keyboard with say, a mobile display, the user can simply detach a keyboard housing from a dock, while optionally leaving one or more devices, items, etc., standing against the dock, which, as explained, may include a retractable bar. In such an example, the dock may remain plugged-in, where the dock is a plug-in dock.

As explained, a keyboard housing may be provided with minimal battery power, which may help to reduce its weight. As explained, a keyboard housing may be magnetically attached to a mobile display device, which may be an accessory display or a tablet computing device. In such an example, magnets and/or other features that provide for coupling the keyboard housing to a dock may be utilized to couple the keyboard housing to the mobile display device to allow for easy transport. In such a scenario, when a user is ready to type, the user can remove the keyboard housing from the mobile display device and place the keyboard housing on a surface (e.g., a tabletop, a desktop, a countertop, a laptop, etc.) and utilize the keyboard housing for a suitable amount of time (e.g., as may be determined via battery power).

As an example, a keyboard housing may include one or more solar cells such that it can be utilized for a longer time than a battery life. In such an example, the keyboard housing may be suitable for outdoor use where sufficient sunlight is available to power circuitry of the keyboard housing. For example, with reference to the example keyboard housing 300 of FIG. 2, one or more of the non-key areas may include one or more solar cells, particularly in areas that would not normally be covered by a hand or hands of a user, which may cast shadows. As solar cells can be relatively flat and lightweight, they may not contribute to a substantially thicker or heavier keyboard housing.

As an example, a system can include a keyboard housing and a dock where the keyboard housing may be a replaceable unit. For example, consider a scenario where a key of the keyboard housing malfunctions or otherwise breaks. In such an example, the keyboard housing alone may be replaced while keeping the dock for use with a new, replacement keyboard housing.

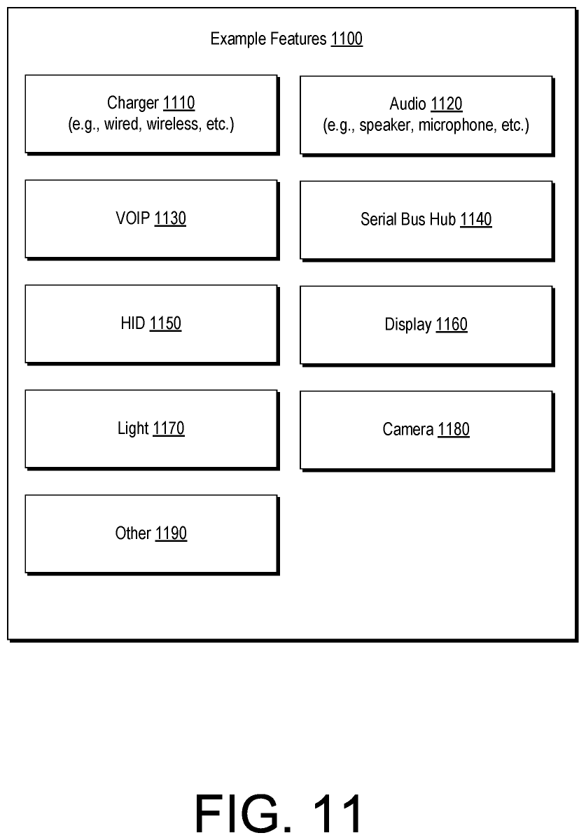

FIG. 11 shows some examples of features 1100 of the dock 400 dock, which can include a charger 1110, audio 1120, voice over Internet protocol (VOIP) 1130, a serial bus hub 1140, a human input device (HID) 1150, a display 1160, a light 1170, a camera 1180 and/or one or more other features 1190.

As an example, a light may be one or more of a beauty light, a reading light, a keyboard illumination light, etc. For example, consider a LED or LEDs on an arm that can be folded down or unfolded and extended. As an example, a camera may be positioned on an arm, optionally with or without a light and/or a microphone. As an example, a keyboard dock can include an extendible arm or extendible arms that may provide for positioning of an arm mounted light, an arm mounted camera, an arm mounted microphone, a stylus holder, etc.

As an example, a dock may include a recess (e.g., a cavity, etc.) for storing an extendible arm. For example, a user may deploy an arm from a dock with one or more circuitry features, a stylus mount, etc. As an example, an arm may be hinged and/or may include a swivel joint, a ball joint, etc. and/or may include a telescoping arrangement of arm pieces. As an example, an arm may be deployable from a top surface, a back surface or an end of a dock. For example, consider an arm that can extend outwardly from a left end or a right end of a dock.

As an example, a dock may include one or more of the features of FIG. 9. As an example, audio capabilities can include BLUETOOTH audio (e.g., BLUETOOTH speaker(s)), VOIP capabilities can include VOIP controls (e.g., for making calls, receiving calls, call controls such as mute, volume, terminate, etc.), a serial bus hub may be or include a USB hub, a display may be a OLED display, a secondary screen, a touch screen, etc., a HID may be or include a mouse, a touchpad, etc., another feature may be a game feature (e.g., a game or gaming keyboard dock, etc.), etc.

As an example, a system can include a dock that includes a base housing that includes a planar docking surface; and a keyboard housing that magnetically couples to the planar docking surface, where the keyboard housing includes a keyboard that includes depressible keys. Depressible keys can include mechanical components where a spring or other biasing mechanism allows for depression and return of a key.

As an example, a dock can include a support adjacent to a base housing of the dock where, for example, the dock can include a hinge that couples the support and the base housing.

As an example, a dock can include a support adjacent to a base housing where the support can be disposed at a non-planar angle with respect to the base housing. In such an example, a keyboard housing can magnetically couples to a planar docking surface of the base housing to form a mobile device stand at least in part between a back edge of the keyboard housing and a front surface of the support. In such an example, a slot can be formed where the slot can be utilized to stand a mobile device, for example, at a suitable viewing angle of a display of the mobile device.

As an example, a base housing of a dock can include circuitry that couples to circuitry of the keyboard housing via an interface. In such an example, the interface can be one or more of a power interface and a data interface. As an example, an interface may be a wireless interface. As an example, a keyboard housing can be provided that does not have an exposed electrical connector. For example, such a keyboard housing may be wireless for power and data or can include a battery and be wireless for data. Where an exposed electrical connector is not included, a keyboard housing may be made lighter and/or thinner, where a relatively light and/or thin battery is provided (e.g., AAA, AA, coin form factor, etc.).

As an example, an interface can be an electrical contact interface, which may or may not be spring biased. For example, consider a pogo-pin interface with spring-biased pins that can be electrical contacts that can contact other electrical contacts, which may or may not be spring-biased.

As an example, a base housing can include a display that includes a display surface. For example, a base housing can be a display device, a mobile device, a mobile display device, etc. As an example, a planar docking surface of a dock can occupy a portion of a display surface. For example, a keyboard housing can dock to a display side of a display device, tablet, etc. In such an example, circuitry of a keyboard housing can operatively couple to circuitry of a base housing for receipt via a keyboard of input for one or more graphical user interfaces rendered to the display. For example, a keyboard of a keyboard housing may be used when attached to a display side or a back side of a display device or when detached form the display device.

As an example, a base housing can include opposing surfaces where one surface is a display surface (e.g., front surface) and another surface is a back surface, opposite the display surface. In such an example, a planar docking surface can occupy a portion of the opposing surface. For example, a keyboard housing can dock to a side opposite a display side of a display device, tablet, etc.

As an example, a planar docking surface of a base housing can be a first docking surface that occupies a portion of a display surface and where the base housing further includes a second planar docking surface that occupies a portion of an opposing surface, opposite the display surface. For example, a base housing can be a display device housing such as a tablet housing where a keyboard housing can dock to a display side or an opposite side.

As an example, a base housing can be a housing of a tablet computing device. In such an example, the base housing can carry a display (e.g., a display panel) that is viewable from a front side of the base housing.

As an example, a dock can include e circuitry and a keyboard housing can include circuitry that operatively couples to the circuitry of the dock. In such an example, the circuitries can operatively couple responsive to magnetic coupling of the keyboard housing to the planar docking surface. As an example, such circuitries can operatively couple responsive to magnetic decoupling of the keyboard housing from the planar docking surface.

As an example, a system can include a mobile display device that includes a planar docking surface where a keyboard housing magnetically couples to the planar docking surface of the mobile display device and where the keyboard housing magnetically couples to the planar docking surface of the base housing.

As an example, an area of a base housing can exceed an area of a keyboard housing. As an example, a base housing can have a rectangular footprint where a keyboard housing has a smaller rectangular footprint. As an example, a keyboard housing can have a thickness that is less than 1.5 cm or, for example, less than or equal to 1 cm.

As an example, a computer program product can include instructions to instruct a computing device, a computing system, etc., to perform one or more methods.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory card, a storage disk, etc.) and referred to as a computer-readable storage medium.

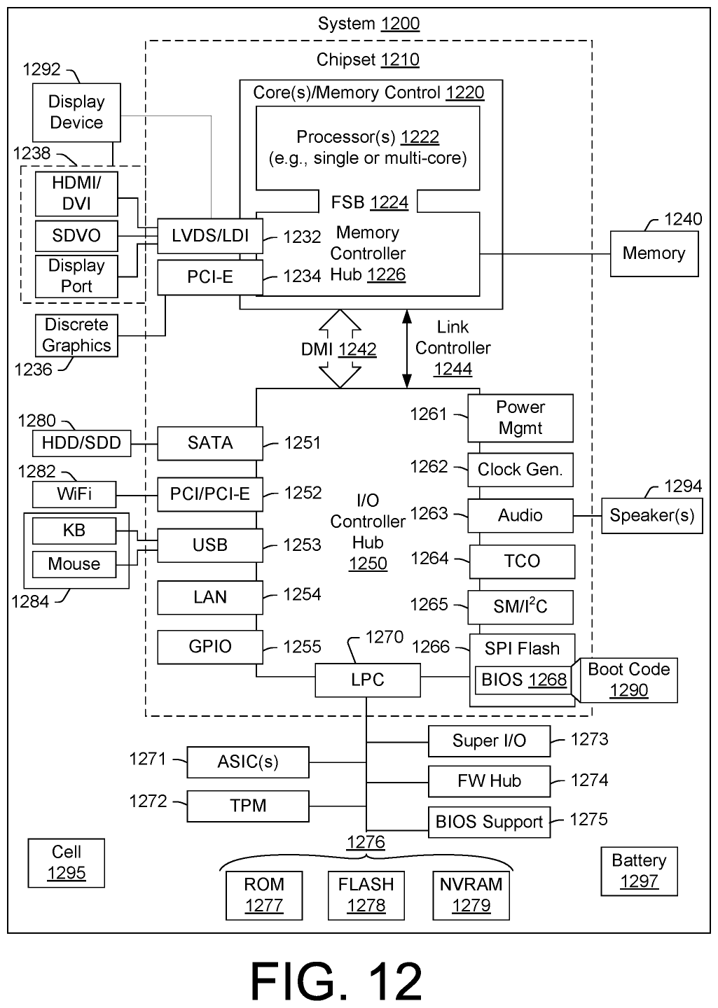

While various examples of circuits or circuitry have been discussed, FIG. 12 depicts a block diagram of an illustrative computer system 1200. The system 1200 may be a computer system sold by Lenovo (US) Inc. of Morrisville, NC (e.g., a THINKSTATION® system, etc.); however, as apparent from the description herein, a satellite, a base, a display, a dock, a keyboard, a computing device, a server or other machine may include one or more features and/or other features of the system 1200.

As an example, a monitor or display may include features such as one or more of the features included in one of the LENOVO® IDEACENTRE® or THINKCENTRE® “all-in-one” (AIO) computing devices (e.g., sold by Lenovo (US) Inc. of Morrisville, NC). For example, the LENOVO® IDEACENTRE® A720 computing device includes an Intel® Core i7 processor, a 27 inch frameless multi-touch display (e.g., for HD resolution of 1920×1080), a NVIDIA® GeForce® GT 630M 2 GB graphics card, 8 GB DDR3 memory, a hard drive, a DVD reader/writer, integrated Bluetooth® and 802.11b/g/n Wi-Fi®, USB connectors, a 6-in-1 card reader, a webcam, HDMI in/out, speakers, and a TV tuner.

As shown in FIG. 12, the system 1200 includes a so-called chipset 1210. A chipset refers to a group of integrated circuits, or chips, that are designed to work together. Chipsets are usually marketed as a single product (e.g., consider chipsets marketed under the brands INTEL®, AMD®, etc.).

In the example of FIG. 12, the chipset 1210 has a particular architecture, which may vary to some extent depending on brand or manufacturer. The architecture of the chipset 1210 includes a core and memory control group 1220 and an I/O controller hub 1250 that exchange information (e.g., data, signals, commands, etc.) via, for example, a direct management interface or direct media interface (DMI) 1242 or a link controller 1244. In the example of FIG. 12, the DMI 1242 is a chip-to-chip interface (sometimes referred to as being a link between a “northbridge” and a “southbridge”).

The core and memory control group 1220 include one or more processors 1222 (e.g., single core or multi-core) and a memory controller hub 1226 that exchange information via a front side bus (FSB) 1224. As described herein, various components of the core and memory control group 1220 may be integrated onto a single processor die, for example, to make a chip that supplants the conventional “northbridge” style architecture.

The memory controller hub 1226 interfaces with memory 1240. For example, the memory controller hub 1226 may provide support for DDR SDRAM memory (e.g., DDR, DDR2, DDR3, etc.). In general, the memory 1240 is a type of random-access memory (RAM). It is often referred to as “system memory”.

The memory controller hub 1226 further includes a low-voltage differential signaling interface (LVDS) 1232. The LVDS 1232 may be a so-called LVDS Display Interface (LDI) for support of a display device 1292 (e.g., a CRT, a flat panel, a projector, etc.). A block 1238 includes some examples of technologies that may be supported via the LVDS interface 1232 (e.g., serial digital video, HDMI/DVI, display port). The memory controller hub 1226 also includes one or more PCI-express interfaces (PCI-E) 1234, for example, for support of discrete graphics 1236. Discrete graphics using a PCI-E interface has become an alternative approach to an accelerated graphics port (AGP). For example, the memory controller hub 1226 may include a 16-lane (×16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1250 includes a variety of interfaces. The example of FIG. 12 includes a SATA interface 1251, one or more PCI-E interfaces 1252 (optionally one or more legacy PCI interfaces), one or more USB interfaces 1253, a LAN interface 1254 (more generally a network interface), a general purpose I/O interface (GPIO) 1255, a low-pin count (LPC) interface 1270, a power management interface 1261, a clock generator interface 1262, an audio interface 1263 (e.g., for speakers 1294), a total cost of operation (TCO) interface 1264, a system management bus interface (e.g., a multi-master serial computer bus interface) 1265, and a serial peripheral flash memory/controller interface (SPI Flash) 1266, which, in the example of FIG. 12, includes BIOS 1268 and boot code 1290. With respect to network connections, the I/O hub controller 1250 may include integrated gigabit Ethernet controller lines multiplexed with a PCI-E interface port. Other network features may operate independent of a PCI-E interface.

The interfaces of the I/O hub controller 1250 provide for communication with various devices, networks, etc. For example, the SATA interface 1251 provides for reading, writing or reading and writing information on one or more drives 1280 such as HDDs, SDDs or a combination thereof. The I/O hub controller 1250 may also include an advanced host controller interface (AHCI) to support one or more drives 1280. The PCI-E interface 1252 allows for wireless connections 1282 to devices, networks, etc. The USB interface 1253 provides for input devices 1284 such as keyboards (KB), one or more optical sensors, mice and various other devices (e.g., microphones, cameras, phones, storage, media players, etc.). On or more other types of sensors may optionally rely on the USB interface 1253 or another interface (e.g., I²C, etc.). As to microphones, the system 1200 of FIG. 12 may include hardware (e.g., audio card) appropriately configured for receipt of sound (e.g., user voice, ambient sound, etc.).

In the example of FIG. 12, the LPC interface 1270 provides for use of one or more ASICs 1271, a trusted platform module (TPM) 1272, a super I/O 1273, a firmware hub 1274, BIOS support 1275 as well as various types of memory 1276 such as ROM 1277, Flash 1278, and non-volatile RAM (NVRAM) 1279. With respect to the TPM 1272, this module may be in the form of a chip that can be used to authenticate software and hardware devices. For example, a TPM may be capable of performing platform authentication and may be used to verify that a system seeking access is the expected system.

The system 1200, upon power on, may be configured to execute boot code 1290 for the BIOS 1268, as stored within the SPI Flash 1266, and thereafter processes data under the control of one or more operating systems and application software (e.g., stored in system memory 1240). An operating system may be stored in any of a variety of locations and accessed, for example, according to instructions of the BIOS 1268. Again, as described herein, a satellite, a base, a server or other machine may include fewer or more features than shown in the system 1200 of FIG. 12. Further, the system 1200 of FIG. 12 is shown as optionally include cell phone circuitry 1295, which may include GSM, CDMA, etc., types of circuitry configured for coordinated operation with one or more of the other features of the system 1200. As shown, the system 1200 may include one or more batteries 1297 and, for example, battery management circuitry.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A system comprising:
a dock that comprises a base housing that comprises a planar docking surface; and
a keyboard housing that magnetically couples to the planar docking surface, wherein the keyboard housing comprises a keyboard that comprises depressible keys.

2. The system of claim 1, wherein the dock comprises a support adjacent to the base housing.

3. The system of claim 2, wherein the dock comprises a hinge that couples the support and the base housing.

4. The system of claim 2, wherein the support is disposed at a non-planar angle with respect to the base housing.

5. The system of claim 4, wherein the keyboard housing magnetically couples to the planar docking surface to form a slot of a mobile device stand at least in part between a back edge of the keyboard housing and a front surface of the support.

6. The system of claim 1, wherein the base housing comprises circuitry that couples to circuitry of the keyboard housing via an interface.

7. The system of claim 6, wherein the interface comprises one or more of a power interface and a data interface.

8. The system of claim 6, wherein the interface comprises a wireless interface.

9. The system of claim 8, wherein the keyboard housing does not have an exposed electrical connector.

10. The system of claim 6, wherein the interface comprises an electrical contact interface.

11. The system of claim 1, wherein the base housing comprises a display that comprises a display surface.

12. The system of claim 11, wherein the planar docking surface occupies a portion of the display surface.

13. The system of claim 12, wherein circuitry of the keyboard housing operatively couples to circuitry of the base housing for receipt via the keyboard of input for one or more graphical user interfaces rendered to the display.

14. The system of claim 11, wherein the base housing comprises an opposing surface, opposite the display surface, wherein the planar docking surface occupies a portion of the opposing surface.

15. The system of claim 11, wherein the planar docking surface is a first docking surface that occupies a portion of the display surface and wherein the base housing further comprises a second planar docking surface that occupies a portion of an opposing surface, opposite the display surface.

16. The system of claim 11, wherein the base housing is a tablet computing device.

17. The system of claim 1, wherein the dock comprises circuitry and wherein the keyboard housing comprises circuitry that operatively couples to the circuitry of the dock responsive to magnetic coupling of the keyboard housing to the planar docking surface.

18. The system of claim 1, wherein the dock comprises circuitry and wherein the keyboard housing comprises circuitry that operatively couples to the circuitry of the dock responsive to magnetic decoupling of the keyboard housing from the planar docking surface.

19. The system of claim 1, comprising a mobile display device that comprises a planar docking surface wherein the keyboard housing magnetically couples to the planar docking surface of the mobile display device and wherein the keyboard housing magnetically couples to the planar docking surface of the base housing.

20. The system of claim 1, wherein an area of the base housing exceeds an area of the keyboard housing and wherein the keyboard housing comprises a thickness that is less than 1.5 cm.
